(19) United States
(12) Patent Application Publication
(10) Pub. No.: US 2015/0181170 A1
(43) Pub. Date: Jun. 25, 2015

(54) INFORMATION ASSOCIATING APPARATUS, METHOD THEREOF AND PROGRAM THEREFOR

(71) Applicant: KABUSHIKI KAISHA TOSHIBA, Tokyo (JP)

(72) Inventors: Tomokazu KAWAHARA, Yokohama-shi (JP); Tatsuo KOZAKAYA, Kawasaki-shi (JP); Masayuki MARUYAMA, Koto-ku (JP); Osamu YAMAGUCHI, Yokohama-shi (JP); Quoc Viet PHAM, Yokohama-shi (JP)

(21) Appl. No.: 14/575,437

(22) Filed: Dec. 18, 2014

(30) Foreign Application Priority Data
Dec. 24, 2013 (JP) 2013-265617

(51) Int. Cl. H04N 7/18; G06K 9/18

(52) U.S. Cl. CPC H04N 7/18; G06K 9/18

(57) ABSTRACT

According to one embodiment, an information associating apparatus includes an acquisition unit configured to acquire an acquisition image taken by a camera and individual identification information of the camera, an analysis unit configured to analyze attribute information of the camera from an attribute information expression body shown in the acquisition image, a detection unit configured to detect an pattern representing a specific direction recorded in the acquisition image and an association unit configured to form a pair by associating the individual identification information and the attribute information based on a detection result concerning the specific direction calculated from the pattern.

### CROSS-REFERENCE TO RELATED APPLICATIONS

This application is based upon and claims the benefit of priority from the prior Japanese Patent Application No. 2013-265617, filed on Dec. 24, 2013; the entire contents of which are incorporated herein by reference.

### FIELD

Embodiments described herein relate to an information associating apparatus, a method thereof, and a program therefor.

### BACKGROUND

In related art, in order to add attribute information to surveillance cameras installed in a building or the like, there is proposed a method in which a two-dimensional bar code or pattern is presented to each surveillance camera, and attribute information of the surveillance camera is added based on information extracted from the two-dimensional bar code or pattern recorded on an image taken by the surveillance camera.

In a camera system including surveillance cameras, it is necessary to add different attribute information to surveillance cameras. However, when the two-dimensional bar code or pattern is presented to one surveillance camera in the case where surveillance cameras take images of the same place, the two-dimensional bar code or pattern is recorded by another surveillance camera, which causes a problem that wrong attribute information is acquired by an unintended surveillance camera in the related-art method.

In view of the above problem, an object of the embodiments described herein is to provide an information associating apparatus capable of associating attribute information only with an intended camera.

### BRIEF DESCRIPTION OF THE DRAWINGS

FIG. 1 illustrates a view showing an installation state of surveillance cameras according to Embodiment 1;

FIG. 2 illustrates a block diagram showing an information associating apparatus according to Embodiment 1;

FIG. 3 illustrates an attribute table showing an attribute pattern and attribute information;

FIG. 4A illustrates a view showing an attribute pattern facing a front direction, and FIG. 4B illustrates a view showing an attribute pattern not facing the front direction;

FIG. 5A illustrates a view showing an attribute pattern of a body facing the front direction, and FIG. 5B illustrates an attribute pattern of a body not facing the front direction;

FIG. 6 illustrates a pair table stored in a storage unit;

FIG. 7 illustrates a flowchart showing processing of the information associating apparatus according to Embodiment 1;

FIG. 8 illustrates a block diagram showing a hardware configuration example of the information associating apparatus according to Embodiment 1;

FIG. 9 illustrates a block diagram showing an example of a hardware configuration according to a modification example of Embodiment 1;

FIG. 10 illustrates a block diagram showing an information associating apparatus according to Embodiment 2;

FIG. 11 illustrates an example of a pair table stored in a storage unit according to Embodiment 2;

FIG. 12 illustrates a flowchart showing processing of an information associating apparatus according to Embodiment 2;

FIG. 13 illustrates an image obtained by imaging a head of an operator who holds a message board by a surveillance camera from above according to Embodiment 3; and

FIG. 14 illustrates an image obtained by imaging a cap of an operator who holds a message board by a surveillance camera from above according to Embodiment 3;

### DETAILED DESCRIPTION

According to embodiments, an information associating apparatus includes an acquisition unit configured to acquire an acquisition image taken by a camera and individual identification information of the camera, an analysis unit configured to analyze attribute information of the camera from an attribute information expression body shown in the acquisition image, a detection unit configured to detect an pattern representing a specific direction recorded in the acquisition image and an association unit configured to form a pair by associating the individual identification information and the attribute information based on a detection result concerning the specific direction calculated from the pattern.

Various Embodiments will be described hereinafter with reference to the accompanying drawings.

### Embodiment 1

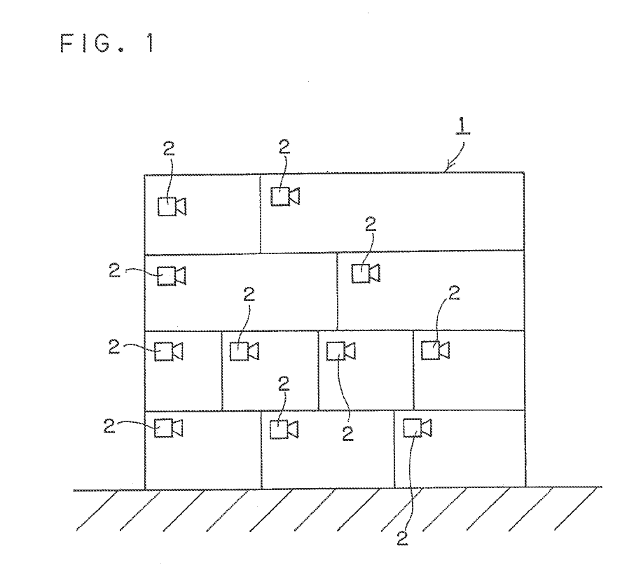

An information associating apparatus 10 according to Embodiment 1 will be explained with reference to FIG. 1 to

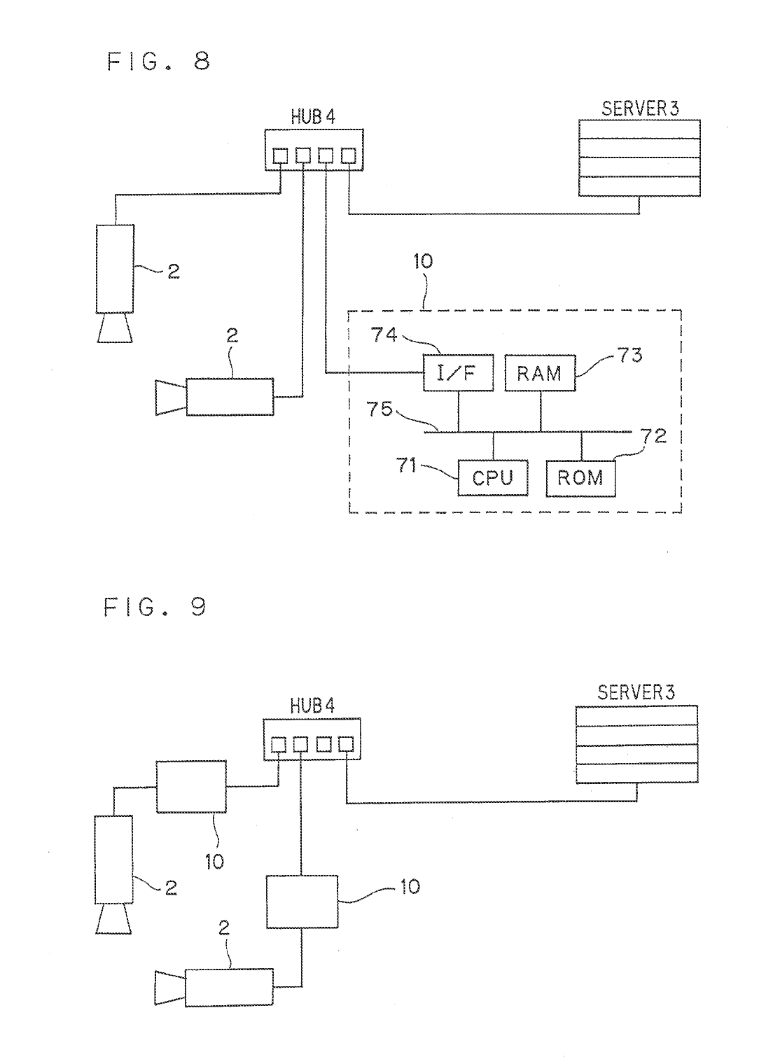

FIG. 9. The explanation will be made by citing a specific example of FIG. 1 for making the explanation about the information associating apparatus 10 according to the embodiment easy to understand. That is, surveillance cameras 2 are respectively installed at rooms, sections, corridors and so on in a multistory building 1 which is, for example, a building or an institute such as a department store, a super market, a company and a public office. A work of associating respective installation positions, respective imaging targets and imaging directions of these surveillance cameras 2 with respective individual identification numbers of respective surveillance cameras 2 is performed by the information associating apparatus 10. The work of association is performed by an operator with respect to respective surveillance cameras 2 one by one by using the information associating apparatus 10, for example, before the building 1 is completed and after the surveillance cameras 2 are respectively installed in the building 1. The work may be performed after the building 1 is completed. That is in a case of, for example, changing the layout. The imaging targets are not limited to objects inside the building 1 but may be objects outside the building 1 (for example, the outside of an entrance, a garden and so on).

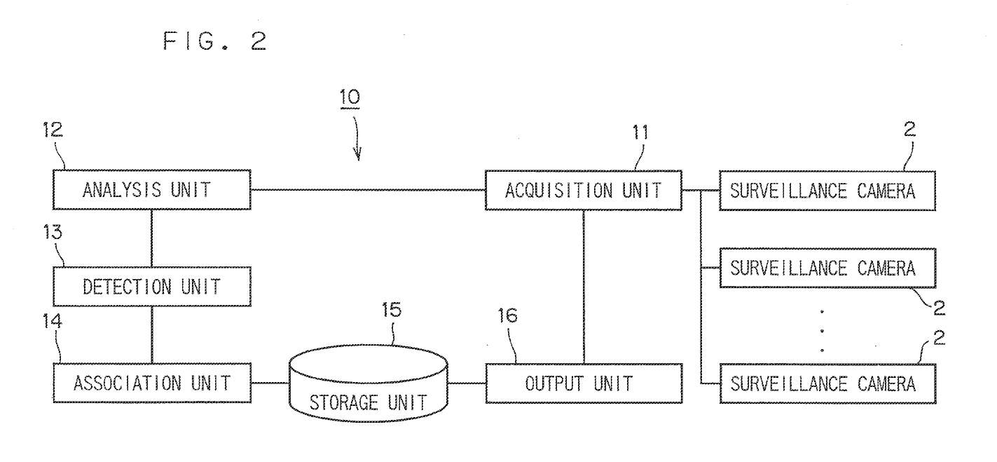

The information associating apparatus 10 includes an acquisition unit 11, an analysis unit 12, a detection unit 13, an association unit 14, a storage unit 15 and an output unit 16 as shown in a block diagram of FIG. 2. Respective units 11 to 16 will be sequentially explained below.

The acquisition unit 11 is connected to surveillance cameras 2, which acquires acquisition images imaged by respective surveillance cameras 2 and individual identification information of respective surveillance cameras 2. In the acquisition image, an attribute information expression body expressing attribute information and an pattern are recorded.

The “individual identification information” means a serial number allocated to each surveillance camera 2, a production number, or an IP address and a name on a network when connected to the network. The attribute information expression body and the pattern will be described later.

The analysis unit 12 detects the attribute information expression body recorded in the acquisition image and analyzes attribute information.

Here, the “attribute information expression body” means an attribute pattern, a bar code or a character string.

In the “attribute pattern”, one attribute information is expressed by a combination of one or two or more of the kind of a geometric figure (shapes of polygons such as a triangle and a quadrangle, and a circle), the color of the figure, the size of the figure and the orientation of the figure in a plane. The attribute information may include plural kinds of figures, or the same kind of figure and may express the positional relation or an arrangement state of the figures such as up and down, right and left.

The “bar code” is a bar code or a two-dimensional bar code representing information by line widths of a striped pattern, which expresses attribute information.

The “character string” is a string of characters extracted from the acquisition image by using OCR or the like, which expresses attribute information.

The “attribute information” is information indicating an installation position and so on of the surveillance camera 2. For example, concerning the surveillance camera 2 installed inside the building 1, the attribute information includes an installation floor, the installation position, an installation height, an imaging target, an imaging direction and a combination of them. When a position where high security is necessary (for example, a position of installation of an ATM) is surveyed, surveillance cameras 2 having the same attribute information (the same installation position, the same imaging target and the same imaging method) may be installed so that the surveillance can be continued even when one surveillance camera 2 fails.

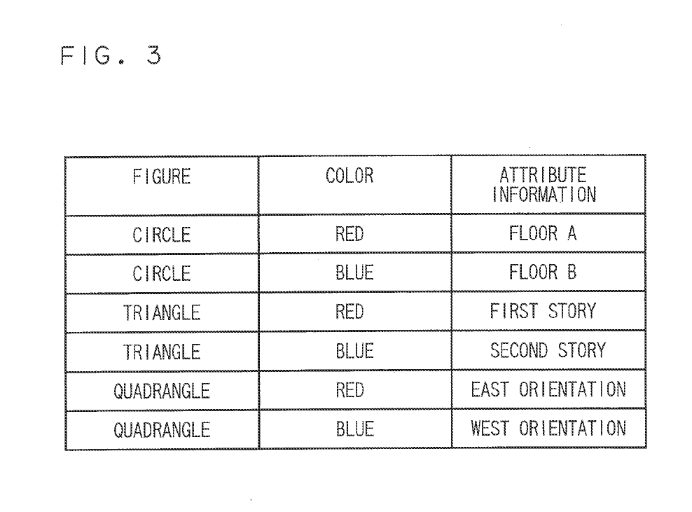

As an analysis method by the analysis unit 12, for example, an attribute table in which the attribute patterns are previously associated with attribute information is prepared as shown in FIG. 3. Then, the analysis unit 12 calculates a recognition score of the attribute pattern by using a template of the figure stored in the attribute table by template matching, then, compares the recognition score with an attribute threshold which is previously prepared. Next, the analysis unit 12 determines that the attribute pattern in the acquisition image exists in the position when the recognition score is higher than the attribute threshold, then, calls attribute information corresponding to the detected attribute pattern from the attribute table.

The detection unit 13 detects an pattern facing a front direction from the acquisition image.

The “pattern” means a kind of a figure and the like which can be detected only when the figure faces the front direction, which includes, for example, a combination of one or two or more of the kind of a figure (shapes of polygons such as a triangle and a quadrangle, and a circle), the color of the figure, the size of the figure and the orientation of the figure in a plane in the same manner as the attribute pattern.

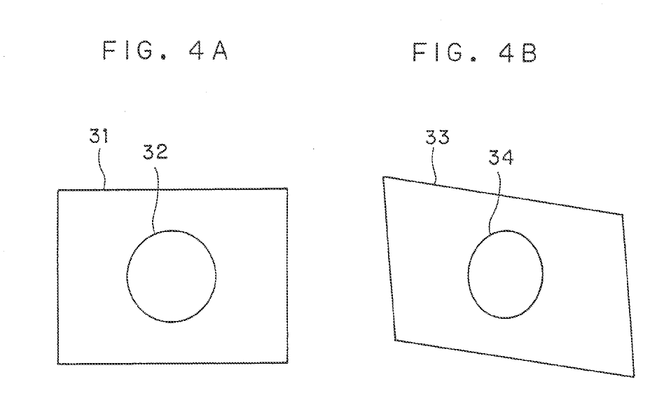

The detection unit 13 prepares an orientation table of figures representing patterns. Then, the detection unit 13 calculates a recognition score of the pattern by using a template of the figure stored in the attribute table by template matching, then, compares the recognition score with the orientation threshold which is previously prepared. Next, the detection unit 13 determines that the pattern in the acquisition image faces the front direction when the recognition score is higher than the orientation threshold, then, detects only the pattern facing the front direction. For example, in the case where a message board on which a circle 32 is drawn is recorded in the acquisition image taken by the surveillance camera 2 as shown in FIG. 4A, the recognition score of the circle by the template matching is high and exceeds the orientation threshold as the recorded circle 32 is a perfect circle, therefore, the detection unit 13 can determine that the circle is the pattern facing the front direction. The orientation threshold is set to a higher value than the attribute threshold in the analysis unit 12, which allows the recognition by the template matching to be highly accurate.

On the other hand, in the case where a board on which a circle 34 is drawn is recorded in the acquisition image taken by the surveillance camera 2 as shown in FIG. 4B, the recognition score of the circle by the template matching is low and does not exceed the orientation threshold as the recorded circle 34 is an ellipse, and the detection unit 13 can determine that the figure is an oblique pattern.

In the case where plural figures are included in the pattern, the detection unit 13 may detect a value determined based on the size, distance and positional relation of the detected figures as an orientation threshold. For example, as the distance between figures is reduced when the surveillance camera 2 takes an image of two figures from an oblique direction, the distance is set as the orientation threshold, thereby detecting only the pattern facing the front direction. When the ratio of sizes of figures and the distance between figures is used as the pattern, effects of the depth from the surveillance camera 2 can be removed.

Concerning the “attribute pattern” and the “pattern”, a figure common to both patterns can be used. Hereinafter, both patterns will be collectively referred to as a “pattern”. For example, when the circle pattern is used, the circle pattern is the attribute pattern as well as the pattern.

As the “pattern”, a face or a body may be used in addition to the figure. In the detection of the face, for example, the method described in Non-Patent Document 1 is used and in the detection of the body, the method described in Non-Patent Document 2 is used. In these methods, the detection unit 13 detects a face or body facing the front direction by learning a detection dictionary by using acquisition images on which faces and bodies facing the front direction are recorded.

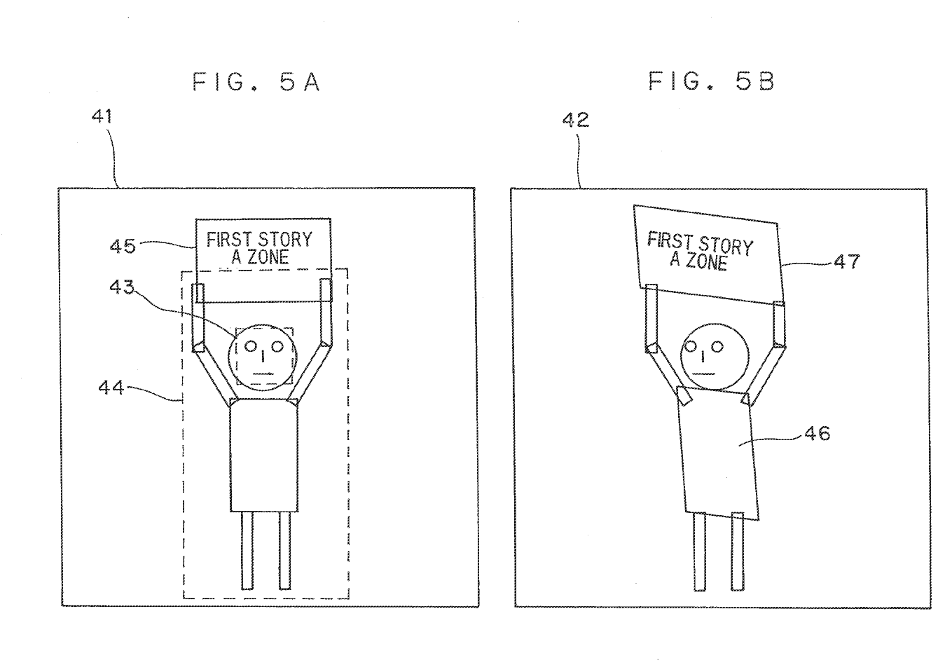

FIG. 5A shows an acquisition image 41 taken by the surveillance camera 2 in which the operator intends to perform association of attribute information, and FIG. 5B shows an acquisition image 42 taken by another surveillance camera 2 in which the operator does not intend to perform association of attribute information. In the acquisition image 41 taken by the intended surveillance camera 2 shown in FIG. 5A, the analysis unit 12 can detect a message board 45 on which the attribute information expression body is written, and the detection unit 13 can detect the pattern of a face 43 or body 44 which faces the front direction as the operator faces the front direction. In the acquisition image 42 taken by the unintended surveillance camera 2 shown in FIG. 5B, the analysis unit 13 can detect a message board 47 on which the attribute information expression body is written, however, it is difficult that the detection unit 12 detects the pattern facing the front direction as an operator 46 does not face the front direction.

The association unit 14 forms a pair by associating attribute information analyzed by the analysis unit 12 with individual identification information of the surveillance camera 2 when the detection unit 13 detects the pattern facing the front direction, and stores the pair in the storage unit 15.

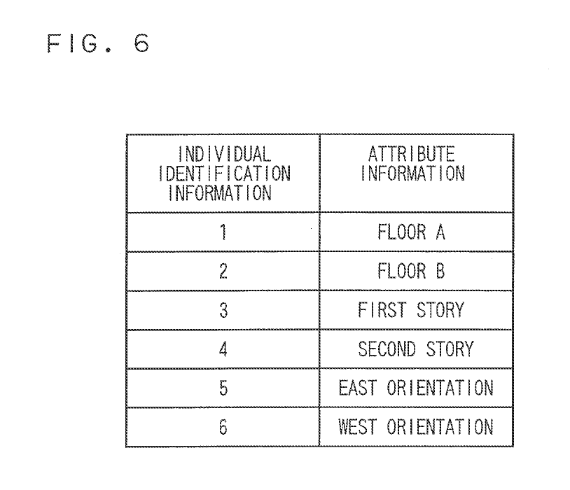

The storage unit 15 stores the pair of the attribution information and the individual identification information of the surveillance camera 2 associated based on the association unit 14. For example, the storage unit 15 stores a pair table representing pairs of individual identification information of the surveillance cameras 2 and attribute information as shown in FIG. 6.

When the output unit 16 outputs output information such as the acquisition image acquired by the acquisition unit 11, the output unit 16 calls the individual identification information of the surveillance camera 2 which has taken the acquisition image from the storage unit 15 and outputs the information with the output information.

The “output information” means the acquisition image, a processed image obtained as a result of performing image processing to the acquisition image or recognition information obtained from the acquisition image by performing recognition processing.

The “recognition information” means, for example, the number of faces, the number of bodies in the acquisition image, IDs of recognized bodies, the circulation and the congestion degree of bodies in the image. Additionally, the brightness of the acquisition image or states of failures of the surveillance cameras 2 may be included.

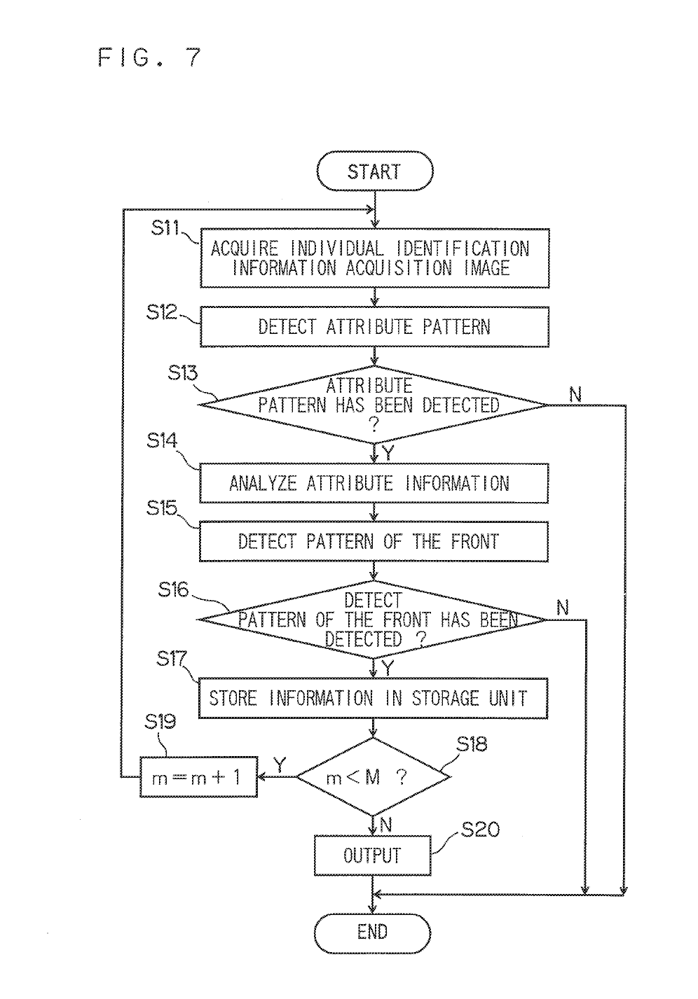

The processing of the information associating apparatus 10 will be explained based on a flowchart of FIG. 7.

The surveillance cameras 2 in the building 1 are all operated to be in a state where the acquisition image can be taken.

Then, the operators stand in front of respective surveillance cameras 2 while holding message boards shown in FIGS. 4A, 4B or FIGS. 5A, 5B. The surveillance cameras 2 take images of the message boards held by the operators and input the acquisition images.

In Step S11, the acquisition unit 11 acquires an acquisition image taken by the surveillance camera 2 and individual identification information of the surveillance camera 2. The acquisition unit 11 outputs the acquisition image to the analysis unit 12 and the detection unit 13, and outputs the individual identification information of the surveillance camera 2 to the association unit 14 and the output unit 16. The acquisition unit 11 may output the individual identification information of the surveillance camera 2 only to the association unit 14. Then, the process proceeds to Step S12.

In Step S12, the analysis unit 12 detects the attribute pattern, the bar code or the character string from the acquisition image. Then, the process proceeds to Step S13.

In Step S13, the process proceeds to Step S14 in the case where the analysis unit 12 has detected the attribute pattern, the bar code or the character string, and the process ends in the case where the detection by the analysis unit 12 has failed.

In Step S14, the analysis unit 12 analyzes attribute information from the detected attribute pattern, the bar code or the character string. The analysis unit 12 outputs the analyzed attribute information to the association unit 14. Then, the process proceeds to Step S15.

In Step S15, the detection unit 13 detects the pattern facing the front direction from the acquisition image. Then, the process proceeds to Step S16.

In Step S16, in the case where the pattern facing the front direction has been detected, the detection unit 13 outputs that effect to the association unit 14 and proceeds to Step S17 (in the case of Y). In the case where the detection has failed, the process ends (in the case of N).

In Step S17, as the detection unit 13 has detected the pattern facing the front direction, the association unit 14 forms a pair by associating attribute information analyzed by the analysis unit 12 with individual identification information of the surveillance camera 2 from the acquisition unit 11, storing the pair in the storage unit 15. Then, the process proceeds to Step S18.

In Step S18, the association unit 14 determines whether pairs of individual identification information of all surveillance cameras 2 in the building 1 and the attribute information have been stored in the storage unit or not based on a total number M of the individual identification information. When a stored number m is equal to the total number M, the association unit 14 determines that the pairs have been stored, and proceeds to Step S20 (in the case of N). When the total number M is higher than the stored number m, the association unit 14 determines that all pairs are not stored, and proceeds to Step S19 (in the case of Y).

In Step S19, the association unit 14 proceeds to Step S11 after incrementing the stored number m by 1 (m=m+1), and the operators stand in front of next surveillance cameras 2 while holding message boards.

In Step S20, the output unit 16 outputs output information such as the acquisition images acquired by the acquisition unit 11 and the individual identification information of the surveillance cameras 2 which have taken these acquisition images and ends the processing.

According to the embodiment, only the pairs of individual identification information and attribute information corresponding to acquisition images in which the pattern facing the front direction has been detected are stored, therefore, the attribute information can be added only to the surveillance camera 2 intended by the operator.

A hardware configuration example of a camera system including the information associating apparatus 10 will be explained based on a block diagram of FIG. 8. In the camera system, surveillance cameras 2, a server 3 and the information associating apparatus 10 are connected by a hub 4.

As shown in FIG. 8, the information associating apparatus 10 includes a CPU 71, a ROM 72 storing a detection program for detecting a target from the acquisition image and so on, a RAM 73, an I/F 74 as an interface for acquiring the image and a bus 75, having a hardware configuration using a normal computer. The CPU 71, the ROM 72, the RAM 73 and the I/F 74 are mutually connected through the bus 75.

In the information associating apparatus 10, when the CPU 71 reads a program from the ROM 72 to the RAM 73 and executes the program, the respective units (the acquisition unit 11, the analysis unit 12, the detection unit 13, the association unit 14, the storage unit 15, the output unit and so on) are realized on the computer, performing detection processing from the I/F 74.

The program may be stored in the ROM 72. It is also preferable that the program is stored in a computer connected to a network such as Internet and downloaded through the network to be provided. It is further preferable that the program is provided or distributed through the network such as Internet.

It is also preferable that plural information associating apparatuses 10 exist, and these apparatuses may be connected to the hub 4.

It is also preferable to apply a configuration in which the surveillance cameras 2 are not connected to the hub 4 but directly connected to the information associating apparatuses 10 as shown in FIG. 9.

### Embodiment 2

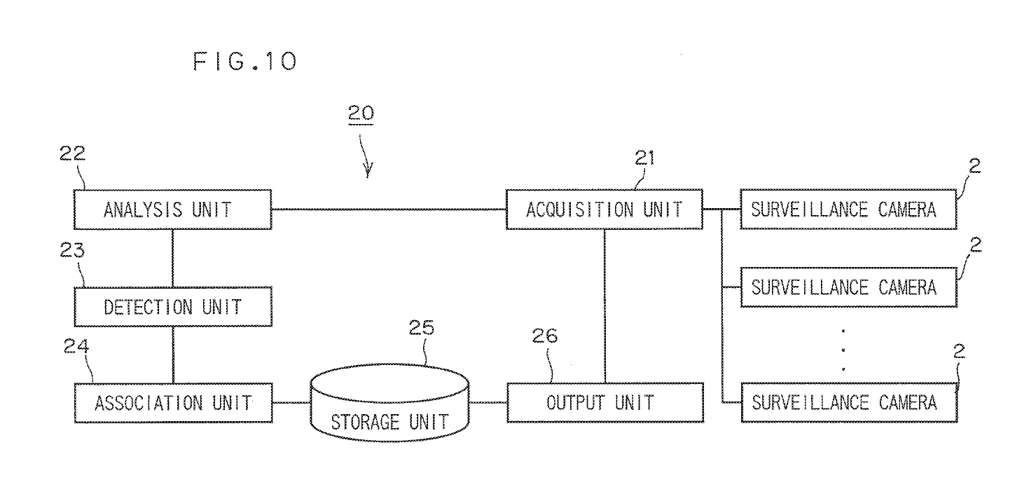

An information associating apparatus 20 according to Embodiment 2 will be explained with reference to FIG. 10 to FIG. 12.

A configuration of the information associating apparatus 20 according to Embodiment 2 will be explained with reference to a block diagram of FIG. 10. The information associating apparatus 20 includes an acquisition unit 21, an analysis unit 22, a detection unit 23, an association unit 24, a storage unit 25 and an output unit 26. Among them, the acquisition unit 21, the analysis unit 22 and the detection unit 23 have the same configurations and functions as the acquisition unit 11, the analysis unit 12 and the detection unit 13 in the information associating apparatus 10 according to Embodiment 1, therefore, the explanation thereof is omitted.

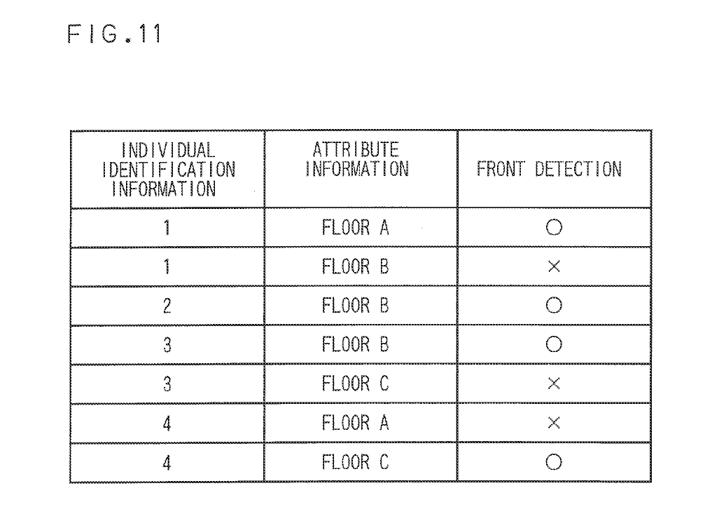

The association unit 24 forms a pair by associating existence of the pattern facing the front direction from the detected unit 23, the attribute information from the analysis unit 22 and individual identification information of the surveillance camera 2 with one another, and stores the pair in the storage unit 25. For example, the association unit 24 stores a pair table including the individual identification information of the surveillance cameras 2, attribute information and the detection result of the pattern shown in FIG. 11 in the storage unit 25. Here, the detection result of the pattern means whether the pattern facing the front direction has been detected or not.

The output unit 26, when outputting output information such as the acquisition image acquired by the acquisition unit 21, calls the individual identification information of the surveillance camera 2 which has taken the acquisition image and the existence of the pattern from the storage unit 25 and outputs the information with the output information.

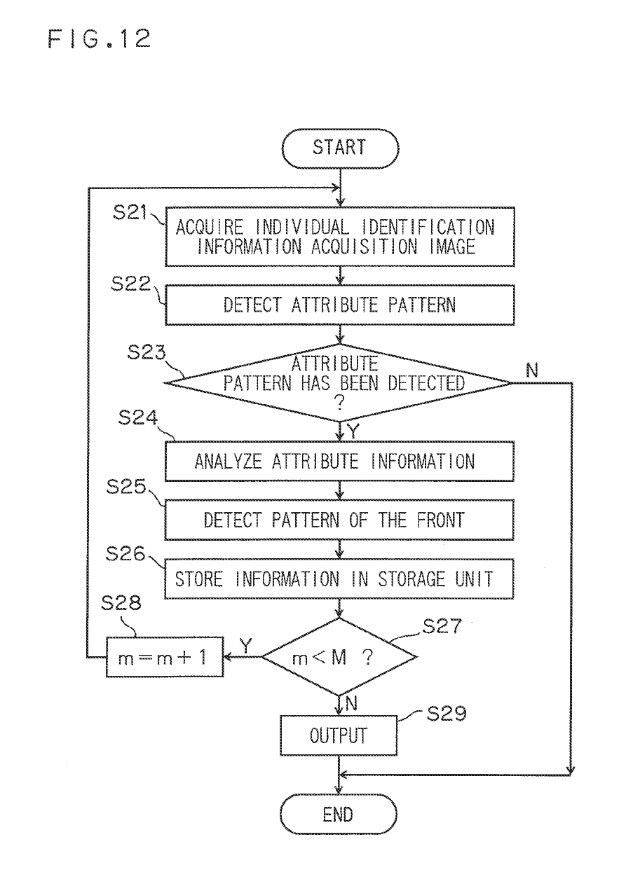

The processing of the information associating apparatus 20 will be explained based on a flowchart of FIG. 12.

As the processing of Step S21 to Step S24 is the same as the processing of Step S11 to Step S14 of Embodiment 1, the explanation thereof is omitted.

In Step S25, the detection unit 23 detects the existence of the pattern facing the front direction from the acquisition image. Then, the process proceeds to Step S26.

In Step S26, the association unit 24 forms a pair by associating existence of the pattern facing the front direction, the attribute information analyzed by the analysis unit 22 and individual identification information of the surveillance camera 2 from the acquisition unit 21 with one another, and stores the pair in the storage unit 25. Then, the process proceeds to Step S27.

In Step S27, the association unit 24 determines whether pairs including individual identification information of all surveillance cameras 2 in the building 1 and the attribute information have been stored in the storage unit 25 or not based on the total number M of the individual identification information. When the stored number m is equal to the total number M, the association unit 24 determines that the pairs have been stored, and proceeds to Step S29 (in the case of N). When the total number M is higher than the stored number m, the association unit 24 determines that all pairs are not stored, and proceeds to Step S28 (in the case of Y).

In Step S28, the association unit 24 proceeds to Step S21 after incrementing the stored number m by 1 (m=m+1), and the operators stand in front of next surveillance cameras 2 while holding message boards.

In Step S29, the output unit 26 outputs output information such as the acquisition images acquired by the acquisition unit 21, the existence of the pattern facing the front direction and the individual identification information of the surveillance cameras 2 which have taken these acquisition images and ends the processing.

According to the embodiment, it is possible to store pairs including individual identification information and attribute information of not only the acquisition images from which the pattern facing the front direction has been detected but also acquisition images corresponding to another pattern.

### Embodiment 3

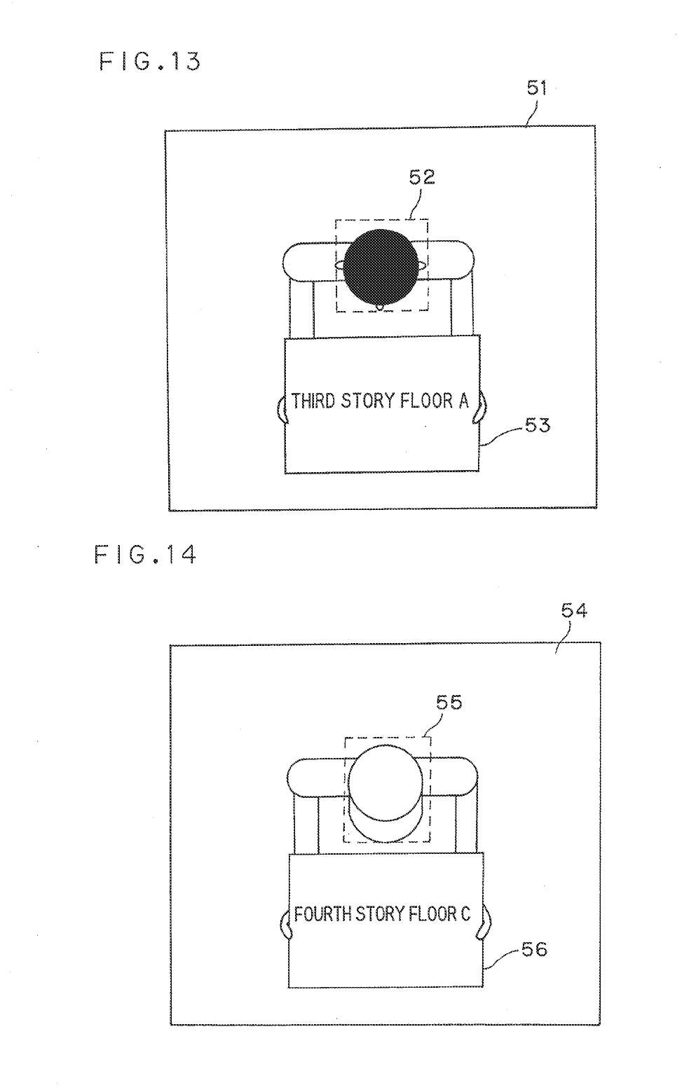

An information associating apparatus 30 according to Embodiment 3 will be explained with reference to FIG. 13 and FIG. 14.

In the above respective embodiments, the pattern facing the front direction has been detected in the detection unit 13, however, there is a surveillance camera 2 installed on a ceiling and does not take an image of the front face of the operator. In this case, the detection unit 13 detects an pattern facing a right-above direction, not the pattern facing the front direction.

For example, as shown in FIG. 13 or FIG. 14, the surveillance camera 2 takes an image of a head 52 or a cap 55 of an operator holding a message board 53 or a message board 56 on which the attribute information expression body is written, and the acquisition unit 11 acquires the image and the individual identification information of the surveillance camera 2.

The analysis unit 12 analyzes attribute information from the attribute information expression body on the message board 53 or the message board 56 recorded in the acquisition image.

When the shape of the head 52 or the cap 55 of the operator recorded in the acquisition image is a circle, the detection unit 13 determines that the pattern faces the right-above direction, outputting that effect to the association unit 14.

As the association unit 14 has detected the pattern facing the right-above direction, the association unit 14 forms a pair by associating attribute information with individual identification information of the surveillance camera 2, storing the pair in the storage unit 15.

According to the embodiment, the pattern facing the right-above direction is detected in addition to the pattern facing the front direction, and only the pairs of individual identification information corresponding to the acquisition images and the attribute information are stored, therefore, it is possible to add attribute information only to the surveillance cameras 2 installed on the ceiling, which is intended by the operator.

### Modification Example

Though the surveillance camera 2 has been explained in the above respective embodiments, the invention is not limited to the above and the embodiments can be applied to other camera systems.

When the detection unit 13 detects the pattern, the size of the pattern and the position in the acquisition image may be considered. For example, it is preferable to designate the detection position by performing detection only in the center of the acquisition image. It is also preferable to designate the detection size by setting the size of the template to a specific size.

The camera may include not only a visible light camera but also an infrared camera.

Concerning the pattern detected by the detection unit 13, the pattern facing the front direction and the pattern facing the right-above direction have been explained in the above embodiments, however, other specific directions may be detected. For example, a pattern facing a right lateral direction of the operator can be detected.

Also in the above respective embodiments, the surveillance cameras 2 are installed inside the building 1, however, instead of this, the surveillance cameras 2 may be installed outside the building 1 such as a park, a sports facility, roads and so on, and also may be installed on a ship, an air plane, a vehicle interior and so on.

Also in the above embodiments, the attribute information expression body is written on the message board, however, it is necessary to prepare many message boards when the number of surveillance cameras 2 is large, which is troublesome. Accordingly, it is preferable that attribute information expression bodies are displayed on a display screen of a tablet terminal or a notebook computer with respect to respective surveillance cameras 2. The patterns may also be displayed on the display screen such as the tablet terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information associating apparatus comprising:
an acquisition unit configured to acquire an acquisition image taken by a camera and individual identification information of the camera;
an analysis unit configured to analyze attribute information of the camera from an attribute information expression body recorded in the acquisition image;
a detection unit configured to detect a pattern representing a specific direction recorded in the acquisition image; and
an association unit configured to form a pair by associating the individual identification information and the attribute information based on a detection result concerning the specific direction calculated from the pattern.

2. The apparatus according to claim 1,
wherein the detection unit detects the pattern representing the specific direction,
the association unit forms the pair only when the pattern facing the specific direction is detected and stores the pair in a storage unit.

3. The apparatus according to claim 1,
wherein the association unit stores the detection result concerning the specific direction and the pair together in the storage unit.

4. The apparatus according to claim 1,
wherein the pattern is a face or a body.

5. The apparatus according to claim 1,
wherein the pattern includes figures such as a polygon, a circle, and a combination of geometric figures.

6. The apparatus according to claim 1,
wherein the attribute information expression body is an attribute pattern, a bar code or a character string shown in the acquisition image.

7. The apparatus according to claim 6,
wherein the attribute pattern includes figures such as a polygon, a circle, and a combination of geometric figures.

8. The apparatus according to claim 1,
wherein the specific direction is a front direction or a right-above direction of the pattern.

9. The apparatus according to claim 1,
wherein the attribute information includes an installation position, an installation floor, an installation height, an imaging target or an imaging direction of the camera.

10. The apparatus according to claim 1,
wherein the individual identification information is a serial number allocated to each camera, a production number, an IP address, or a name on a network of each camera.

11. The apparatus according to claim 1,
wherein the camera is a surveillance camera.

12. The apparatus according to claim 1,
wherein the camera is installed on a wall or a ceiling.

13. The apparatus according to claim 1,
wherein the camera is a camera taking images by visible light or an infrared camera.

14. The apparatus according to claim 1,
wherein plural cameras exist, and
these respective cameras take images of the same imaging target.

15. The apparatus according to claim 1, further comprising:
an output unit configured to call the individual identification information of the camera which has taken the acquisition image from the storage unit and to output the individual identification information and output information concerning the acquisition image.

16. The apparatus according to claim 1,
wherein the analysis unit analyzes the attribute information of the camera from the attribute information expression body by template matching using an attribute threshold.

17. The apparatus according to claim 16,
wherein the detection unit detects whether the pattern faces the specific direction or not by template matching using an orientation threshold, and
the orientation threshold is higher than the attribute threshold.

18. The apparatus according to claim 1,
wherein the attribute information expression body of each camera or the pattern is displayed on a display screen of a tablet terminal or a notebook computer.

19. An information associating method comprising:
acquiring an acquisition image taken by a camera and individual identification information of the camera;
analyzing attribute information of the camera from an attribute information expression body recorded in the acquisition image;
detecting an pattern representing a specific direction recorded in the acquisition image; and
forming a pair by associating the individual identification information and the attribute information based on a detection result concerning the specific direction calculated from the pattern.

20. A non-transitory program stored in a computer readable medium, causing a computer to perform functions of:
acquiring an acquisition image taken by a camera and individual identification information of the camera;
analyzing attribute information of the camera from an attribute information expression body recorded in the acquisition image;
detecting an pattern representing a specific direction recorded in the acquisition image; and
forming a pair by associating the individual identification information and the attribute information based on a detection result concerning the specific direction calculated from the pattern.
